(19) United States
(12) Patent Application Publication
(10) Pub. No.: US 2008/0118222 A1
(43) Pub. Date: May 22, 2008

(54) DIGITAL BROADCAST RECEPTION TERMINAL AND METHOD FOR RESERVED RECORDING OF DIGITAL BROADCAST PROGRAMS

(75) Inventor: Seung-Ki CHOI, Gumi-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 11/765,097

(22) Filed: Jun. 19, 2007

(30) Foreign Application Priority Data
Nov. 22, 2006 (KR) 2006-115665

(51) Int. Cl. H04N 5/91

(52) U.S. Cl. 386/83

(57) ABSTRACT

An apparatus and method for performing reserved-recording of a digital broadcast program are provided. The method includes setting a reservation to record a digital broadcast program, activating a timer to determine a start time of the program when the terminal is turned off, turning on the terminal to record the program when the start time of the program is reached stopping the recording at an end time of the program and turning off the terminal. Regardless of whether the terminal is turned on or off, the reserved program can be recorded during a time period between the start time and end time of the program. The terminal is turned on to record the program when the start time is reached and turned off at the end time, thereby reducing battery consumption.

### PRIORITY

This application claims the benefit under 35 U.S.C. §119(a) of a Korean patent application filed in the Korean Intellectual Property Office on Nov. 22, 2006 and assigned Serial No. 2006-115665, the entire disclosure of which is hereby incorporated by reference.

### BACKGROUND OF THE INVENTION

1. Field of the Invention

The present invention relates to a terminal for receiving a digital broadcast. More particularly, the present invention relates to a digital broadcast reception terminal and a method for reserved recording of digital broadcast programs.

2. Description of the Related Art

Digital broadcasting generally refers to high-quality, high-definition audio/video broadcasting services which are generally replacing conventional analog services. Digital broadcasting is broadly divided into digital satellite broadcasting and digital terrestrial broadcasting.

Digital satellite broadcasting offers multi-channel multimedia mobile broadcasting services through a handheld digital TV receiver (e.g. a mobile phone or a personal information terminal) or an in-car digital TV receiver, without the limitations of time and space.

Digital terrestrial broadcasting developed from Digital Audio Broadcasting (DAB; digital radio system) is a new concept in mobile-reception multimedia broadcasting services using an unused VHF Channel 12. Digital terrestrial broadcasting transmits television, radio and data broadcasts over multiple channels.

Rapid development of digital broadcasting and mobile communication technologies has led to an increasing interest in digital broadcasting services that allow people to view digital broadcasts even while moving. Particularly, digital multimedia broadcasting (“DMB”) services offered through mobile communication terminals are attracting keen interest.

FIG. 1 is a view illustrating digital broadcast program guide data stored in a digital broadcast reception terminal.

Digital broadcast program guide data provide information on channels, program start/end times and other program information (such as titles, descriptions and TV ratings of the programs).

Referring to FIG. 1, if a user selects CH 1 from the digital broadcast program guide data, the digital broadcast reception terminal will display the broadcast start/end times (09:00˜10:00, 10:00˜11:00, . . . ), titles (Program 1, Program 2, . . . ), descriptions and age-based TV ratings (18, 15, . . . ) of programs broadcast over the selected channel CH 1.

Typically, digital broadcast program guide data is provided at periodic time intervals or whenever updated.

Digital broadcast reception terminals receive and store the digital broadcast program guide data. In response to the user's request, digital broadcast reception terminals generate digital broadcast program information from the stored data and offer the generated information to the user. Alternatively, the digital broadcast reception terminals receive digital broadcast program guide data and generate the broadcast program information in response to the user's request to view the generated information.

With the commercialization of digital multimedia broadcasting services, a wide range of digital broadcast programs are provided by the digital broadcast service providers. Furthermore, users can set their digital broadcast reception terminals to record desired programs.

However, in a conventional digital broadcast reception terminal, even if a program recording reservation is set, viewers can expect reliable recording only when the digital broadcast reception terminal is turned on.

### SUMMARY OF THE INVENTION

An aspect of the present invention is to address at least the above-mentioned problems and/or disadvantages and to provide at least the advantages described below. Accordingly, an aspect of the present invention is to provide a digital broadcast reception terminal and a method for performing reserved-recording of a digital broadcast program, regardless of whether the terminal is turned on or off.

Another aspect of the present invention is to provide a digital broadcast reception terminal and a method for performing reserved-recording of a digital broadcast program, while reducing battery consumption.

In accordance with one aspect of the present invention, a method for performing reserved-recording of a digital broadcast program in a digital broadcast reception terminal is provided. The method includes setting a recording reservation for at least one digital broadcast program, activating a timer to determine a broadcast start time of the reserved digital broadcast program when the terminal is turned off, turning on the terminal to record the reserved program when the broadcast start time of the reserved program is reached, and stopping the recording at a broadcast end time of the reserved program and turning off the terminal.

In accordance with another aspect of the present invention, a digital broadcast reception terminal is provided. The terminal includes a digital broadcast receiver unit for receiving digital broadcast data and digital broadcast program guide data of digital broadcast programs, a memory for storing the received digital broadcast data and digital broadcast program guide data, a power supply unit for supplying power to the digital broadcast reception terminal when the terminal is turned on, an auxiliary power supply unit for supplying auxiliary power when the terminal is turned off, and a control unit supplied with the auxiliary power to determine the broadcast start and end times of a digital broadcast program reserved for recording when the terminal is turned off, for turning on the terminal to record the reserved program when the broadcast start time of the reserved program is reached, for stopping the recording at the broadcast end time of the reserved program and for turning off the terminal.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 is a view illustrating digital broadcast program guide data stored in a digital broadcast reception terminal;

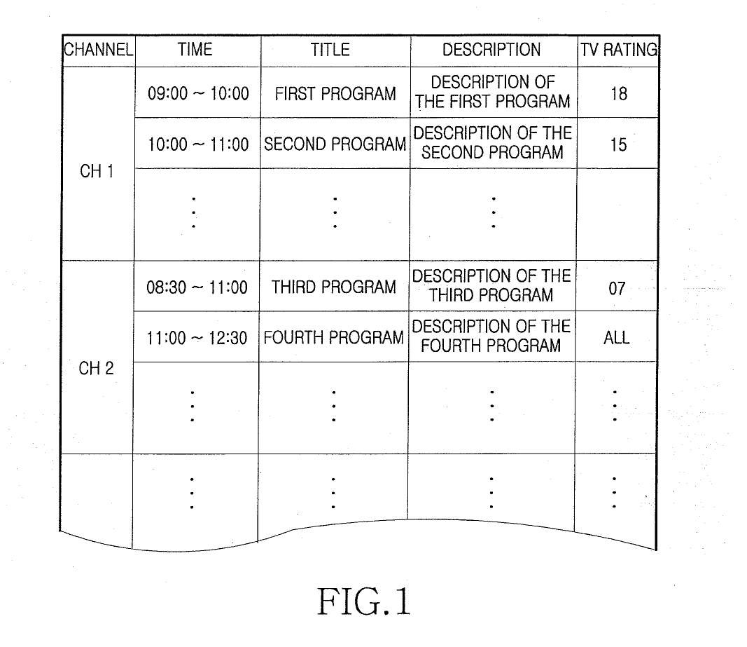

FIG. 2 is a block diagram illustrating a digital broadcast reception terminal according to an exemplary embodiment of the present invention;

FIG. 3 is a flowchart illustrating a process of setting a recording reservation for a digital broadcast program in a digital broadcast reception terminal according to an exemplary embodiment of the present invention;

FIG. 4 is a flowchart illustrating a process of setting a recording reservation for a digital broadcast program in a digital broadcast reception terminal according to another exemplary embodiment of the present invention; and

FIG. 5 is a flowchart illustrating a process of performing reserved-recording of a digital broadcast program in a digital broadcast reception terminal according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

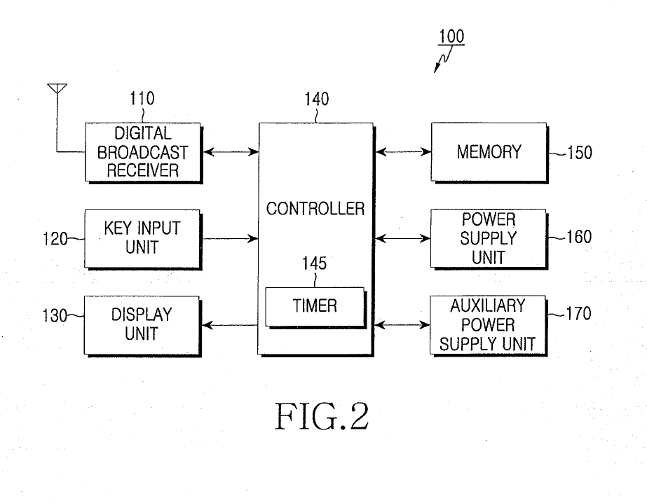

FIG. 2 is a block diagram illustrating a digital broadcast reception terminal according to an exemplary embodiment of the present invention.

The digital broadcast reception terminal 100 includes a digital broadcast receiver unit 110, a key input unit 120, a display unit 130, a control unit 140, a timer 145, a memory 150, a power supply unit 160 and an auxiliary power supply unit 170.

The digital broadcast receiver unit 110 demodulates digital broadcast data received through a specific channel into a digital data transmission stream and outputs the digital data transmission stream to the control unit 140. The digital broadcast data can be satellite digital broadcast data, terrestrial digital broadcast data, digital video broadcast data (for example, DVB-H) and the like.

The digital broadcast receiver unit 110 may include a demodulator (not shown) for demodulating the digital broadcast data into a digital transmission stream.

The key input unit 120 having a key matrix structure (not shown) is provided with alphanumeric keys, function keys, an external volume key and the like. The key input unit 120 outputs a signal corresponding to a key pressed by a user to the control unit 140.

The display unit 130 displays various display data generated from the digital broadcast reception terminal 100. It may comprise a liquid crystal display (LCD). When the LCD is a touch screen display, it can also serve as an input device.

The control unit 140 controls the overall operations of the digital broadcast reception terminal 100. In an exemplary embodiment, the control unit 140 sets a recording reservation for at least one digital broadcast program according to the user's request.

In an exemplary embodiment, the control unit 140 performs the following operation to set a program recording reservation.

When the user inputs a request to record at least one selected digital broadcast program, the control unit 140 detects broadcast information on the selected digital broadcast program from digital broadcast program guide data stored in the memory 150, and separately stores the detected broadcast information in the memory 150. The broadcast information may include the broadcast start time, broadcast end time, channel number, title of the broadcast program and the like.

The control unit 140 requests the user to input the broadcast start and end times of the selected digital broadcast program, and stores the broadcast start and end times input by the user in the memory 150. At this time, the control unit 140 may store the input broadcast start and end times together with the channel number and title of the selected digital broadcast program.

If the user turns off the digital broadcast reception terminal after setting the program recording reservation, the control unit 140 will then activate the timer 145 with the auxiliary power supplied from the auxiliary power supply unit 170 in order to determine the broadcast start and end times of the reserved program. In other words, the control unit 140 determines whether the current time of the timer 145 is the broadcast start or end time of the reserved program. The timer 145 may be included in the control unit 140 or separately provided.

When the broadcast start time of the reserved program is reached, the control unit 140 turns on the digital broadcast reception terminal to record the reserved digital broadcast program. The control unit 140 stops the recording process at the broadcast end time of the reserved program, and turns off the digital broadcast reception terminal.

The memory 150 may comprise a program memory and a data memory. The memory 150 stores programs for controlling the operations of the digital broadcast reception terminal 100 and various information selected by the user. In addition, the memory 150 stores digital broadcast program guide data received through the digital broadcast receiver unit 110 and digital broadcast data of the digital broadcast programs under the control of the control unit 140.

When the digital broadcast reception terminal 100 is turned on, the power supply unit 160 supplies power applied from a battery (not shown) mounted in the terminal 100 to each circuit of the terminal 100. The user can input a power on/off signal using a power key provided on the key input unit 120.

In an exemplary embodiment, when the terminal 100 is turned off, the power supply unit 160 can also supply power to the control unit 140 so that the control unit 140 can activate the timer 145 to determine the time.

The auxiliary power supply unit 170 may be included in the power supply unit 160. The auxiliary power supply unit 170 supplies auxiliary power to the control unit 140 when the terminal 100 is turned off. The control unit 140 activates the timer 145 using the auxiliary power.

Although not shown in FIG. 2, the digital broadcast reception terminal 100 may further include an audio processor which modulates an electric signal input from a microphone into audio data, and which demodulates encoded audio data received from the digital broadcast receiver unit 110 into an electrical signal and outputs the electrical signal through a speaker.

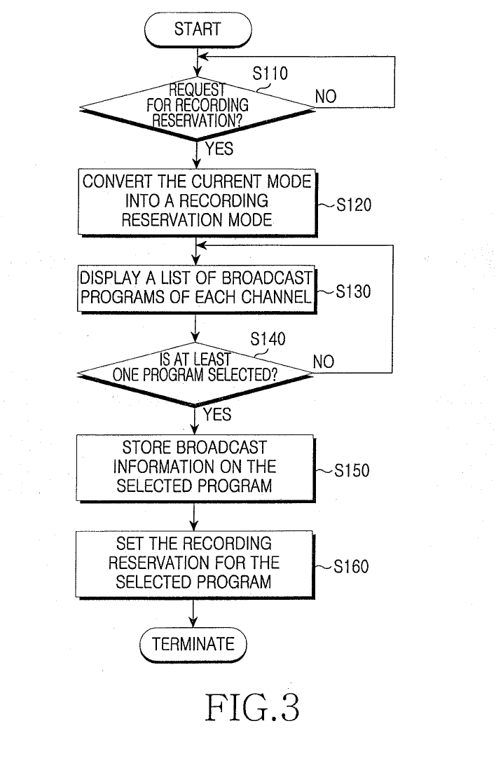

FIG. 3 is a flowchart illustrating a process of setting a recording reservation for a digital broadcast program in a digital broadcast reception terminal according to an exemplary embodiment of the present invention.

Referring to FIGS. 2 and 3, the control unit 140 determines whether the user inputs a request for a program recording reservation in step S110. The user can input the request using the keys provided on the key input unit 120, using a recording reservation menu and the like.

When the request for a program recording reservation is input, the control unit 140 converts the current operation mode of the digital broadcast reception terminal 100 into a recording reservation mode in step S120.

In the recording reservation mode, the control unit 140 generates a list of broadcast programs of each channel from the digital broadcast program guide data stored in the memory 150. The control unit 140 displays the list on the display unit 130 so that the user can easily select a digital broadcast program desired to be recorded in step S130.

The control unit 140 determines whether the user selects at least one digital broadcast program from the display list in step S140. If the key input unit 120 is provided with direction keys, the user can select one or more desired broadcast programs using the direction keys.

When the user selects at least one broadcast program from the list, the control unit 140 stores broadcast information on the selected program in the memory 150 in step S150. The broadcast information may include the broadcast start time, broadcast end time, channel number, title of the selected program and the like. In an exemplary embodiment, the control unit 140 may detect the broadcast information from the digital broadcast program guide data and separately store it in the memory 150.

The control unit 140 sets the recording reservation of the selected program in step S160 then terminates the process.

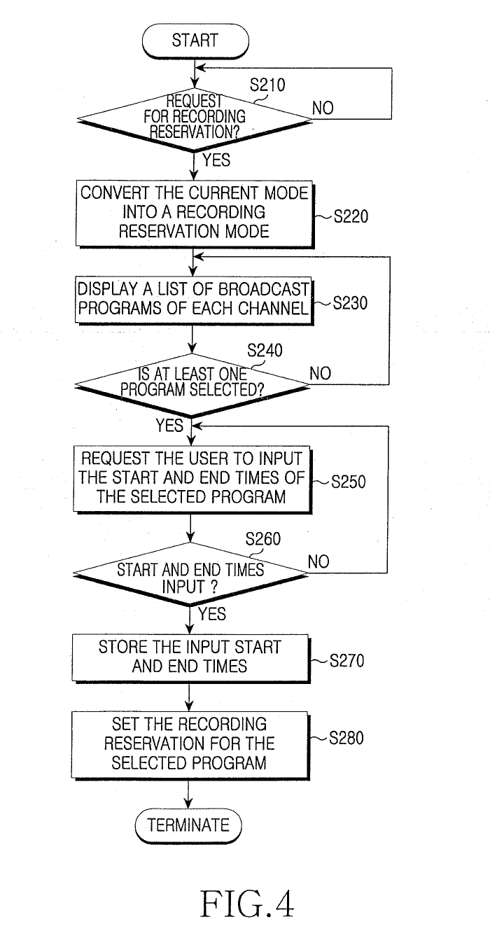

FIG. 4 is a flowchart illustrating a process of setting a recording reservation for a digital broadcast program in a digital broadcast reception terminal according to another exemplary embodiment of the present invention.

Referring to FIGS. 2 and 4, the control unit 140 determines whether the user inputs a request for a program recording reservation in step S210.

When the request is input, the control unit 140 converts the current operation mode of the digital broadcast reception terminal 100 into the recording reservation mode in step S220.

In the recording reservation mode, the control unit 140 generates a list of broadcast programs of each channel from the digital broadcast program guide data stored in the memory 150. The control unit 140 displays the list on the display unit 130 so that the user can easily select a digital broadcast program desired to be recorded in step S230. The list may include broadcast programs of each channel, broadcast information (such as broadcast start and end times) of each program and the like.

The control unit 140 determines whether the user selects at least one digital broadcast program from the display list in step S240.

When the user selects at least one broadcast program from the list, the control unit 140 requests the user to input the broadcast start and end times of the selected digital broadcast program in step S250. At this time, the control unit 140 may output a request in text or voice to input the broadcast start and end times. In an exemplary embodiment, the control unit 140 may generate a window in which the user can input the broadcast start and end times of the selected program.

The control unit 140 determines whether the user has input the broadcast start and end times of the selected program in step S260.

The control unit 140 stores the inputted broadcast start and end times in the memory 150 in step S270.

The control unit 140 sets the recording reservation of the selected program in step S280 then terminates the process.

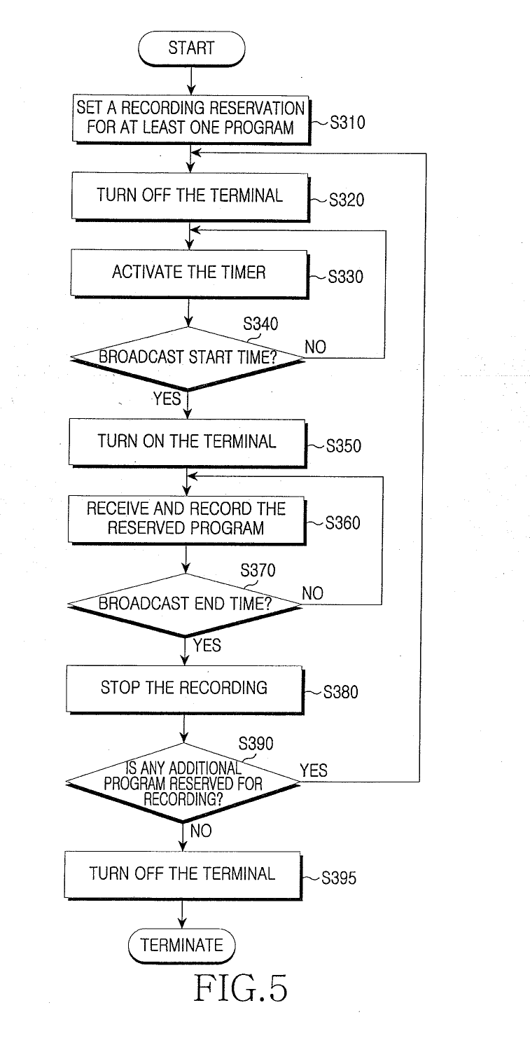

FIG. 5 is a flowchart illustrating a process of performing reserved-recording of a digital broadcast program in a digital broadcast reception terminal according to an exemplary embodiment of the present invention.

Referring to FIGS. 2 and 5, the control unit 140 sets a recording reservation for at least one digital broadcast program according to the user's request in step S310. The process of setting the program recording reservation is substantially the same as those explained in detail with reference to FIGS. 3 and 4 and will not be repeated here for sake of convenience and clarity.

The control unit 140 turns off the digital broadcast reception terminal 100 according to the user's input of a key (for example, a power off key) in step S320.

The control unit 140 activates the timer 145 using the auxiliary power supplied from the auxiliary power supply unit 170 in step S330. When turning off the terminal, the control unit 140 may determine the current time and set the timer 145 to show the current time. In such a case, the control unit 140 can determine the time through the timer 145 even while the terminal is off.

Alternatively, the control unit 140 may check the current time when turning off the terminal, and calculate the difference between the broadcast start and end times of the reserved program and the current time. As an example, assuming that the current time is 3:00 pm and that the reserved program starts at 5:00 pm and ends at 6:00 pm, the difference between the broadcast start time and the current time is two hours. Also, the difference between the broadcast end time and the current time is three hours. The control unit 140 sets such time differences in the timer 145 so that the timer 145 can count down the remaining time to the broadcast start time or end time.

The control unit 140 checks the timer 145 to determine whether the broadcast start time of the reserved program is reached in step S340. If the timer 145 is set to show the current time in step S330, the control unit 140 will determine whether the current time of the timer 145 is the broadcast start time of the reserved program.

On the other hand, if the timer 145 is set to count down the remaining time to the broadcast start time in step S330, the control unit 140 will check when the remaining time is zero.

Upon determining that the broadcast start time of the reserved program is reached in step S340, the control unit 140 turns on the digital broadcast reception terminal 100 and supplies the power applied from the power supply unit 160 to each circuit of the terminal 100 in step S350. At this time, the control unit 140 may cut off the auxiliary power supplied from the auxiliary power supply unit 170.

With the supply of power to each circuit of the terminal 100, the control unit 140 receives digital broadcast data through the digital broadcast receiver unit 110 and records the reserved digital broadcast program in step S360. At this time, the control unit 140 may output an alarm in order to inform the user of the beginning of the reserved-recording. The alarm can be a general bell sound or music. Alternatively, the alarm can be a previously set voice message and the like.

During the recording of the program, the control unit 140 checks the timer 145 to determine whether the broadcast end time of the program is reached in step S370. The control unit 140 checks the broadcast end time by the same method as used in step S340 to check the broadcast start time.

When the broadcast end time is reached, the control unit 140 terminates the recording process in step S380.

The control unit 140 determines whether the recording reservation is set for another digital broadcast program in step S390. In other words, the control unit 140 determines whether any additional program is reserved for recording. If there is an additional program reserved, the control unit 140 will proceed to step S320 and repeat, as needed, the above described process.

If there is no additional program reserved, the control unit 140 will turn off the digital broadcast reception terminal 100 in step S395 and terminate the recording process.

As explained above, a digital broadcast reception terminal according to exemplary embodiments of the present invention can record a reserved digital broadcast program during a time period between the broadcast start time and broadcast end time of the program, regardless of whether it is turned on or off. The digital broadcast reception terminal is turned on to record the reserved program when the broadcast start time is reached, and turned off at the broadcast end time, thereby reducing battery consumption.

Although exemplary embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A method for performing reserved-recording of a digital broadcast program in a digital broadcast reception terminal, the method comprising:
setting a recording reservation in a terminal for at least one digital broadcast program;
activating a timer to determine a broadcast start time of the at least one reserved digital broadcast program when the terminal is turned off;
turning on the terminal to record the reserved program when the broadcast start time of the reserved program is reached; and
stopping the recording at a broadcast end time of the reserved program and turning off the terminal.

2. The method according to claim 1, wherein the setting of the recording reservation comprises:
when a request for recording reservation is input by a user, generating a list of digital broadcast programs of each channel from previously stored digital broadcast program guide data and displaying the generated list; and
when at least one digital broadcast program is selected from the displayed list, detecting broadcast information corresponding to the selected program from the digital broadcast program guide data and storing the detected broadcast information.

3. The method according to claim 2, wherein said broadcast information comprises at least one of the broadcast start time, the broadcast end time, a channel number and a title of the selected program.

4. The method according to claim 1, wherein the setting of the recording reservation comprises:
when a request for recording reservation is input by a user, generating a list of digital broadcast programs of each channel from previously stored digital broadcast program guide data and displaying the generated list;
when at least one digital broadcast program is selected from the displayed list, requesting the user to input the broadcast start time and the broadcast end time of the selected program; and
when the broadcast start and end times of the selected program are input, storing the input broadcast start and end times.

5. The method according to claim 4, wherein said storing of the input broadcast start and end times comprises storing the input broadcast start and end times together with a channel number and a title of the selected broadcast program.

6. The method according to claim 1, further comprising evaluating said broadcast start time to determine whether it comprises the same time as shown in the timer.

7. A digital broadcast reception terminal comprising:
a digital broadcast receiver unit for receiving digital broadcast data and digital broadcast program guide data of digital broadcast programs;
a memory for storing the received digital broadcast data and digital broadcast program guide data;
a power supply unit for supplying power when the terminal is turned on;
an auxiliary power supply unit for supplying power when the terminal is turned off; and
a control unit for determining broadcast start and end times of a digital broadcast program reserved for recording when the terminal is turned off and power is supplied from the auxiliary power supply unit, for turning on the terminal to record the reserved program when the broadcast start time of the reserved program is reached, for stopping the recording at a broadcast end time of the reserved program, and for turning off the terminal.

8. The digital broadcast reception terminal according to claim 7, wherein said power supply unit comprises the auxiliary power supply unit.

9. The digital broadcast reception terminal according to claim 7, wherein said control unit detects a user's request to record at least one selected digital broadcast program, extracts broadcast information on the digital broadcast program from the digital broadcast program guide data, and stores the extracted broadcast information in the memory.

10. The digital broadcast reception terminal according to claim 9, wherein said broadcast information comprises at least one of a broadcast start time, a broadcast end time, a channel number and a title of the selected program.

11. The digital broadcast reception terminal according to claim 7, wherein said control unit detects a user's request to record at least one selected digital broadcast program, requests the user to input a broadcast start time and a broadcast end time of the selected broadcast program, and stores the input broadcast start and end times in the memory.

12. The digital broadcast reception terminal according to claim 11, wherein said control unit stores the broadcast start and end times together with a channel number and a title of the selected broadcast program.

13. The digital broadcast reception terminal according to claim 7, wherein said control unit activates a timer with power supplied from the auxiliary power supply unit to determine whether a time shown in the timer comprises the broadcast start time of the reserved program.

14. The digital broadcast reception terminal according to claim 7, wherein said control unit outputs an alarm before recording the reserved program.

15. A method for performing reserved-recording in a broadcast reception terminal, the method comprising:
setting a recording reservation in a terminal for at least one broadcast program;
turning off the terminal;
supplying power from an auxiliary power source to a timer;
determining, by the timer, a broadcast start time of the at least one reserved broadcast program;
turning on the terminal when the broadcast start time of the reserved program is reached;
recording the reserved program;
stopping the recording at a broadcast end time of the reserved program; and
turning off the terminal.

16. The method according to claim 15, wherein the setting of the recording reservation comprises:
receiving a request for the recording reservation;
generating and displaying a list of broadcast programs corresponding to previously stored data;
detecting broadcast information corresponding to at least one selected program from the data when the at least one broadcast program is selected from the displayed list; and
storing the detected broadcast information.

17. The method according to claim 16, wherein said broadcast information comprises at least one of the broadcast start time, the broadcast end time, a channel number and a title of the selected program.

18. The method according to claim 15, wherein the setting of the recording reservation comprises:
receiving a request for the recording reservation;
generating and displaying a list of broadcast programs from previously stored data;
requesting a user to input the broadcast start time and the broadcast end time of at least one selected program when the at least one broadcast program is selected from the displayed list; and
storing the input broadcast start and end times.

19. The method according to claim 18, wherein said storing of the input broadcast start and end times comprises storing the input broadcast start and end times together with a channel number and a title of the selected broadcast program.

20. The method according to claim 15, further comprising evaluating said broadcast start time to determine whether it comprises the same time as shown in the timer.
